(19) United States
(12) Patent Application Publication
(10) Pub. No.: US 2015/0054657 A1
(43) Pub. Date: Feb. 26, 2015

(54) SOUND FEEDBACK SYSTEM FOR VEHICLES

(71) Applicant: DEERE & COMPANY, MOLINE, IL (US)

(72) Inventors: JULIAN SANCHEZ, LECLAIR, IA (US); KRISTIN J. SULLIVAN, DES MOINES, IA (US); KARL B. WASHBURN, LECLAIRE, IA (US); NOEL W. ANDERSON, FARGO, ND (US)

(73) Assignee: DEERE & COMPANY, MOLINE, IL (US)

(21) Appl. No.: 13/971,051

(22) Filed: Aug. 20, 2013

(51) Int. Cl. G08B 21/18; G08B 3/00

(52) U.S. Cl. CPC G08B 21/18; G08B 3/00
USPC 340/902

(57) ABSTRACT

A feedback system is configured for providing a feedback sound representative of a first vehicle status of a first vehicle and a second vehicle status of a second vehicle. The feedback system comprises a first vehicle data bus of the first vehicle and a second vehicle data bus of the second vehicle. A first wireless communication device communicates with the first vehicle data bus and is configured to communicate first vehicle status data. A second wireless communication device communicates with the second vehicle data bus and is configured to communicate second vehicle status data. An electronic data processing system comprises a third wireless communication device configured to receive the first and second vehicle status data. A sound integration module is configured to form or determine the feedback sound from the first and second vehicle status data. A sound generator module is configured to communicate the feedback sound to a user.

### FIELD OF THE DISCLOSURE

The present disclosure generally relates to a system and method for providing a feedback sound representative of one or more vehicles.

### BACKGROUND OF THE DISCLOSURE

To provide feedback regarding one vehicle to another vehicle, certain prior art utilizes an imaging device and a monitor such that an operator can visually monitor an operational status of one vehicle from another vehicle.

### SUMMARY OF THE DISCLOSURE

In one embodiment, a sound feedback system and method is configured for providing a feedback sound representative of a first vehicle status of a first vehicle and a second vehicle status of a second vehicle. The sound feedback system comprises a first vehicle data bus of the first vehicle and a second vehicle data bus of the second vehicle. A first wireless communication device is in communication with the first vehicle data bus. The first wireless communication device is configured to communicate first vehicle status data. A second wireless communication device is in communication with the second vehicle data bus. The second wireless communication device is configured to communicate second vehicle status data. An electronic data processing system, which comprises a third wireless communication device is configured to receive the first vehicle status data and the second vehicle status data. A sound integration module is configured to form or determine the feedback sound from the first vehicle status data and the second vehicle status data. A sound generator module is configured to communicate the feedback sound to a user.

In another embodiment, a sound feedback system and method is configured for providing a feedback sound representative of a first vehicle status of a first vehicle and a second vehicle status of a second vehicle operating together in a work area. The sound feedback system comprises a first vehicle data bus of the first vehicle. A first wireless communication device is in communication with the first vehicle data bus. The first wireless communication device is configured to receive second vehicle status data from a second wireless communication device of a second vehicle. In the first vehicle, an electronic data processing system is configured to receive first vehicle status data and the second vehicle status data. A sound integration module is capable of forming or determining the feedback sound from the first vehicle status data and the second vehicle status data. A sound generator module is configured to communicate the feedback sound to a user.

In yet another embodiment, a method for providing a feedback sound representative of a first vehicle status of a first vehicle and a second vehicle status of a second vehicle is disclosed. The first vehicle status data and the second vehicle status data are communicated. The first vehicle status data and the second vehicle status data are received. The feedback sound is formed or determined from the first vehicle status data and the second vehicle status data. The feedback sound is communicated to a user.

Other features and aspects will become apparent by consideration of the detailed description and accompanying drawings.

### BRIEF DESCRIPTION OF THE DRAWINGS

FIG. 1 is a schematic of a sound feedback system according to one embodiment.

FIG. 2 is a schematic of a sound feedback system according to another embodiment.

FIG. 3 is a plan view of a first vehicle and a second vehicle incorporating the sound feedback system of FIG. 1 or 2.

FIG. 4 is a flow chart of the steps of the method for providing sound feedback to a user or manager of one or more vehicles according to one embodiment.

FIG. 5 is a flow chart of the steps of the method for providing sound feedback to a user or manager of one or more vehicles according to another embodiment.

FIG. 6 is a flow chart of the steps of the method for providing sound feedback to a user or manager of one or more vehicles according to yet another embodiment.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION

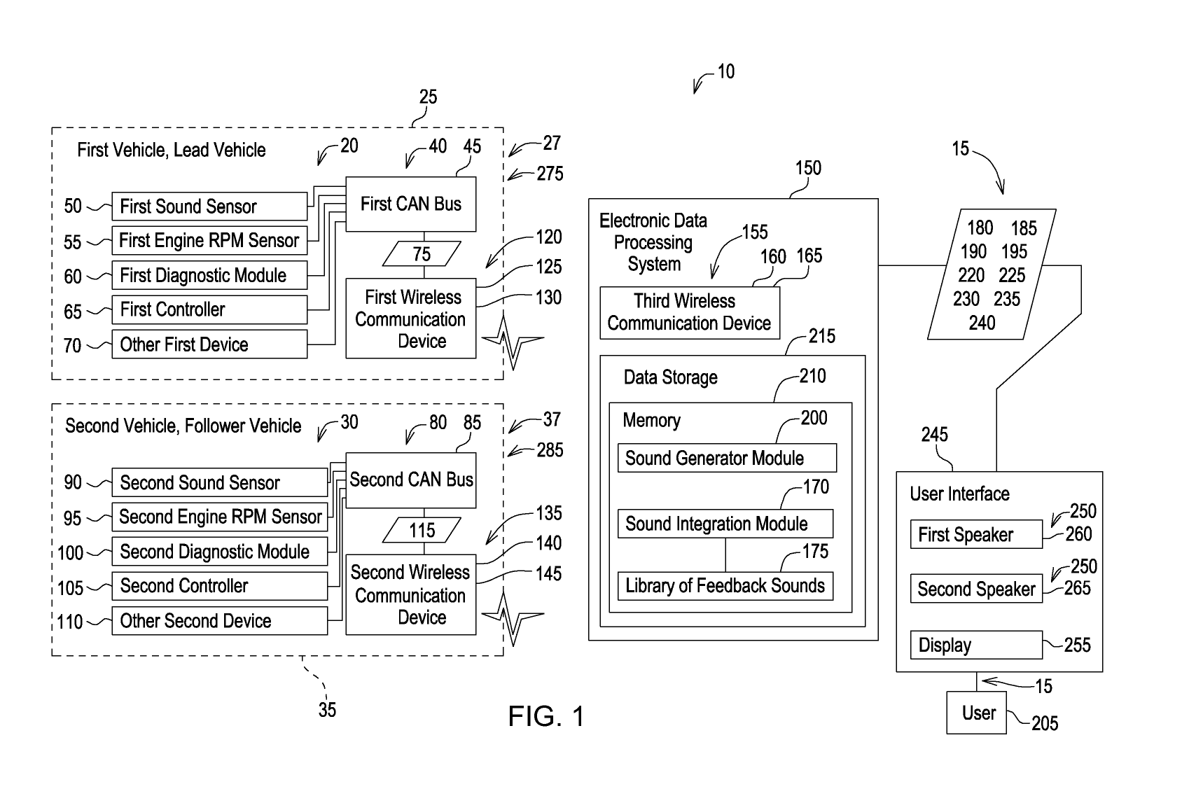

FIGS. 1-6 illustrate various embodiments of a sound feedback system 10 for providing a feedback sound representative of a vehicle. With reference to FIG. 1, in one embodiment the illustrated sound feedback system 10 is configured for providing a feedback sound 15 representative of a first vehicle status 20 of a first vehicle electronics 25 of a first vehicle 27 (e.g., tractor, combine, construction vehicle) and a second vehicle status 30 of a second vehicle electronics 35 of a second vehicle 37 (e.g., tractor, combine, construction vehicle).

The sound feedback system 10 comprises a first vehicle data bus 40 of the first vehicle electronics 25. For example, the first vehicle data bus 40 may be a first CAN bus 45. A first sound sensor 50, or a first engine RPM sensor 55, a first diagnostic module 60, a first controller 65, or other first device 70 (e.g., engine controller, transmission controller, controller, other sensor, network element), may be in communication with the first vehicle data bus 40 to collect and provide first vehicle status data 75 (e.g., ambient sound, engine sound, combine separator). For instance, the first diagnostic module 60 is capable of producing diagnostic codes, alarm data, warning data, trouble codes or status messages as the first vehicle status data 75.

The sound feedback system 10 comprises a second vehicle data bus 80 of the second vehicle electronics 35. For example, the second vehicle data bus 80 may be a second CAN bus 85. A second sound sensor 90, or a second engine RPM sensor 95, a second diagnostic module 100, a second controller 105, or other second device 110 (e.g., engine controller, transmission controller, controller, other sensor, network element), may be in communication with the second vehicle data bus 80 to collect and provide second vehicle status data 115 (e.g., ambient sound, engine sound, combine separator). For instance, the second diagnostic module 100 is capable of producing diagnostic codes, alarm data, warning data, trouble codes or status messages as the second vehicle status data 115.

A first wireless communication device 120 is in communication with the first vehicle data bus 40. The first wireless communication device 120 is configured to communicate the first vehicle status data 75. The first wireless communication device 120 may be a first transceiver 125 or a first transmitter 130.

A second wireless communication device 135 is in communication with the second vehicle data bus 80. The second wireless communication device 135 is configured to communicate the second vehicle status data 115. The second wireless communication device 135 may be a second transceiver 140 or a second transmitter 145.

An electronic data processing system 150 is configured to receive the first vehicle status data 75 and the second vehicle status data 115 from the first vehicle data bus 40 and the second vehicle data bus 80 via the first wireless communication device 120 and the second wireless communication device 135, respectively. The electronic data processing system 150 may comprise a third wireless communication device 155 to communicate with the first wireless communication device 120 and the second wireless communication device 135. The third wireless communication device 155 may be a third transceiver 160 or a receiver 165.

In one embodiment, a sound integration module 170 comprises one or more amplifiers, attenuators, combiners, mixers, multipliers, frequency shifters, analog-to-digital converters, digital-to-analog converters, software emulators, software modules, or electronic modules for processing vehicle status data or vehicle sounds in the analog or digital domain. In one configuration, the sound integration module 170 is adapted to derive, form, or create synthetically-created sounds from one or both of the first vehicle status 20 and the second vehicle status 30, data diagnostic codes, alarm data, warning data, or trouble codes from one or both of the first vehicle electronics 25 and the second vehicle electronics 35, for example.

In an alternate configuration, the sound integration module 170 is capable of generating, combining (equally or weighted), mixing, amplifying, attenuating, frequency shifting, multiplying, creating (e.g., synthetically-derived or synthetically-created vehicle sounds), or processing sounds (e.g., recorded sounds) representative of an operational or functional status of the first vehicle electronics 25, the second vehicle electronics 35, or both.

The sound integration module 170 is configured to form or determine the feedback sound 15 from the first vehicle status data 75 and the second vehicle status data 115. The sound integration module 170 may match the first vehicle status data 75 and the second vehicle status data 115 to a library of feedback sounds 175 and communicate the feedback sound 15.

The sound integration module 170 may be configured to determine whether the first vehicle electronics 25 and the second vehicle electronics 35 are operating properly and form the feedback sound 15 as a dissonant chord 180 if at least one of the first vehicle electronics 25 and the second vehicle electronics 35 is not operating properly and form the feedback sound 15 as a major chord 185 if the first vehicle electronics 25 and the second vehicle electronics 35 are operating properly. The determination of whether the first vehicle electronics 25 and the second vehicle electronics 35 are operating properly may be determined by a threshold deviation between an expected and actual first vehicle status data 75 and second vehicle status data 115.

The sound integration module 170 may be configured to determine whether the first vehicle electronics 25 and the second vehicle electronics 35 are operating properly and form the feedback sound 15 in an amplified manner 190 if at least one of the first vehicle electronics 25 and the second vehicle electronics 35 is not operating properly and form the feedback sound 15 in a non-amplified manner 195 if the first vehicle electronics 25 and the second vehicle electronics 35 are operating properly.

A sound generator module 200 is configured to communicate the feedback sound 15 to a user 205. The sound integration module 170 and the sound generator module 200 may be separate electronic hardware modules or software included in a memory 210 of a data storage 215 of the electronic data processing system 150.

Alternatively, the sound generator module 200 may be configured to determine whether the first vehicle electronics 25 and the second vehicle electronics 35 are operating properly and generate a first tone 220 representative of the first vehicle status data 75 and a second tone 225 representative of the second vehicle status data 115. If at least one of the first vehicle electronics 25 and the second vehicle electronics 35 is not operating properly, the first tone 220 and the second tone 225 may be on different frequencies or spaced apart in the frequencies of a minor chord 230 or a dissonant sound 235. If the first vehicle electronics 25 and the second vehicle electronics 35 are operating properly, the first tone 220 and the second tone 225 may be on the same frequency or spaced on frequencies that form notes of the major chord 185. In addition, the feedback sound 15 may comprise a voice recording 240 if at least one of the first vehicle electronics 25 and the second vehicle electronics 35 is not operating properly. For example, the voice recording 240 may state “check engine” or other phrases.

For example, a user interface 245 comprising a speaker 250 is in communication with the sound generator module 200. The user interface 245 is configured to communicate the feedback sound 15 through the speaker 250. The user interface 245 may provide additional detail on a display 255 (e.g., LCD screen).

Alternatively, the user interface 245 may comprise a first speaker 260 and a second speaker 265. The user interface 245 may be configured to communicate the feedback sound 15 representative of the first vehicle status 20 of the first vehicle electronics 25 primarily through the first speaker 260 and the feedback sound 15 representative of the second vehicle status 30 of the second vehicle electronics 35 primarily through the second speaker 265. This enables a stereo effect, where an illusion of directionality and audible perspective is provided, when the first vehicle electronics 25 and the second vehicle electronics 35 are positioned left and right of one another, the first speaker 260 and the second speaker 265 are positioned left and right of one another, and the feedback sound 15 representative of the vehicle on the left is communicated primarily through the speaker on the left and the feedback sound 15 representative of the vehicle on the right is communicated primarily through the speaker on the right, depending on the relative position of the first vehicle electronics 25 and the second vehicle electronics 35. Once the first vehicle electronics 25 and the second vehicle electronics 35 are positioned adjacent one another, the feedback sound 15 representative of the vehicle on the left and the vehicle on the right may be the same in the first speaker 260 and the second speaker 265. The stereo effect is also possible when the first vehicle electronics 25 and the second vehicle electronics 35 are positioned front and rear of one another, the first speaker 260 and the second speaker 265 are positioned front and rear of one another, and the feedback sound 15 representative of the vehicle in the front is communicated primarily through the speaker in the front and the feedback sound 15 representative of the vehicle in the rear is communicated primarily through the speaker in the rear, depending on the relative position of the first vehicle electronics 25 and the second vehicle electronics 35. Once the first vehicle electronics 25 and the second vehicle electronics 35 are positioned adjacent one another, the feedback sound 15 representative of the vehicle in front and the vehicle in the rear may be the same in the first speaker 260 and the second speaker 265. Other vehicle and speaker configurations are contemplated by this disclosure.

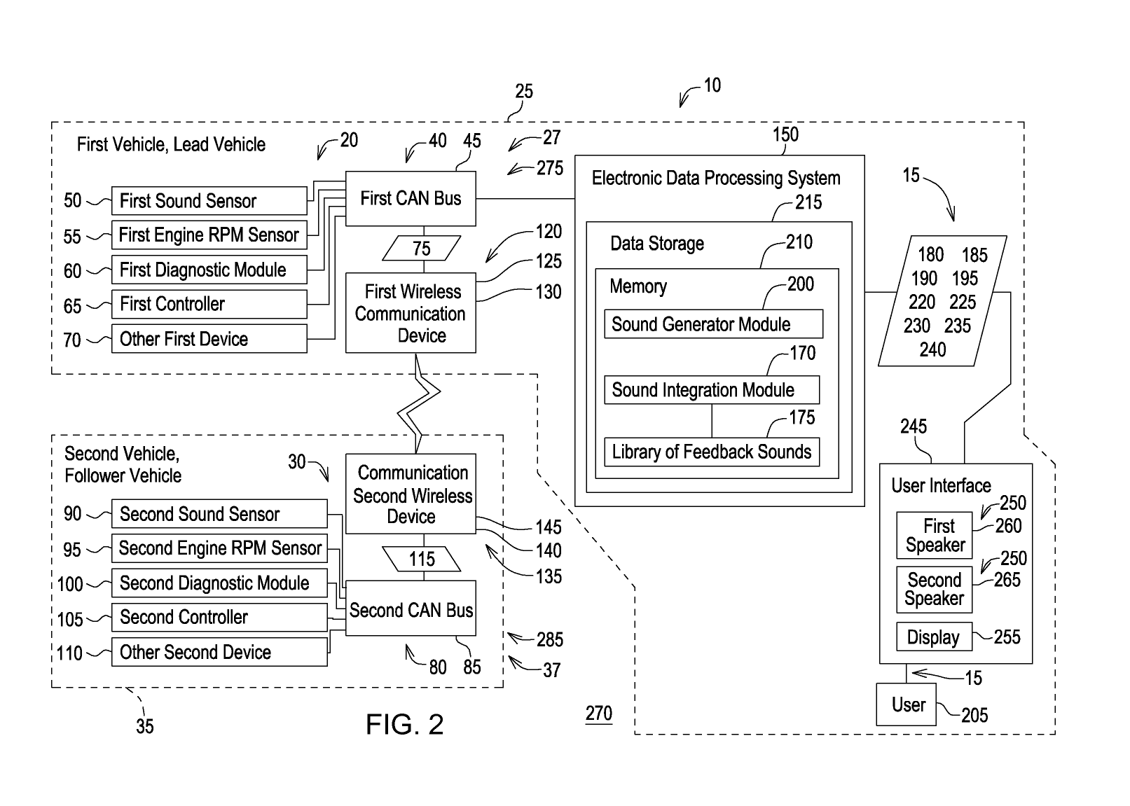

Referring to FIG. 2, in another embodiment, the illustrated feedback system 10 is configured for providing the feedback sound 15 representative of the first vehicle status 20 of the first vehicle electronics 25 (e.g., tractor, combine, construction vehicle) and the second vehicle status 30 of the second vehicle electronics 35 (e.g., tractor, combine, construction vehicle) working together in a work area 270. The feedback system 10 of FIG. 2 is similar to the feedback system 10 of FIG. 1, except that the feedback sound 15 is provided to a user 205 of the first vehicle 27, such as within a cab or at the user interface 245 of the first vehicle 27. Like reference numbers in FIG. 1 and FIG. 2 indicate like elements.

The feedback system 10 comprises the first vehicle data bus 40 of the first vehicle electronics 25. The first wireless communication device 120 is in communication with the first vehicle data bus 40. The first wireless communication device 120 is configured to receive second vehicle status data 115 from the second wireless communication device 135 of the second vehicle electronics 35. In the first vehicle electronics 25, the electronic data processing system 150 is configured to receive the first vehicle status data 75 and the second vehicle status data 115. The sound integration module 170 is capable of forming or determining the feedback sound 15 from the first vehicle status data 75 and the second vehicle status data 115. The sound generator module 200 is configured to communicate the feedback sound 15 to the user 205.

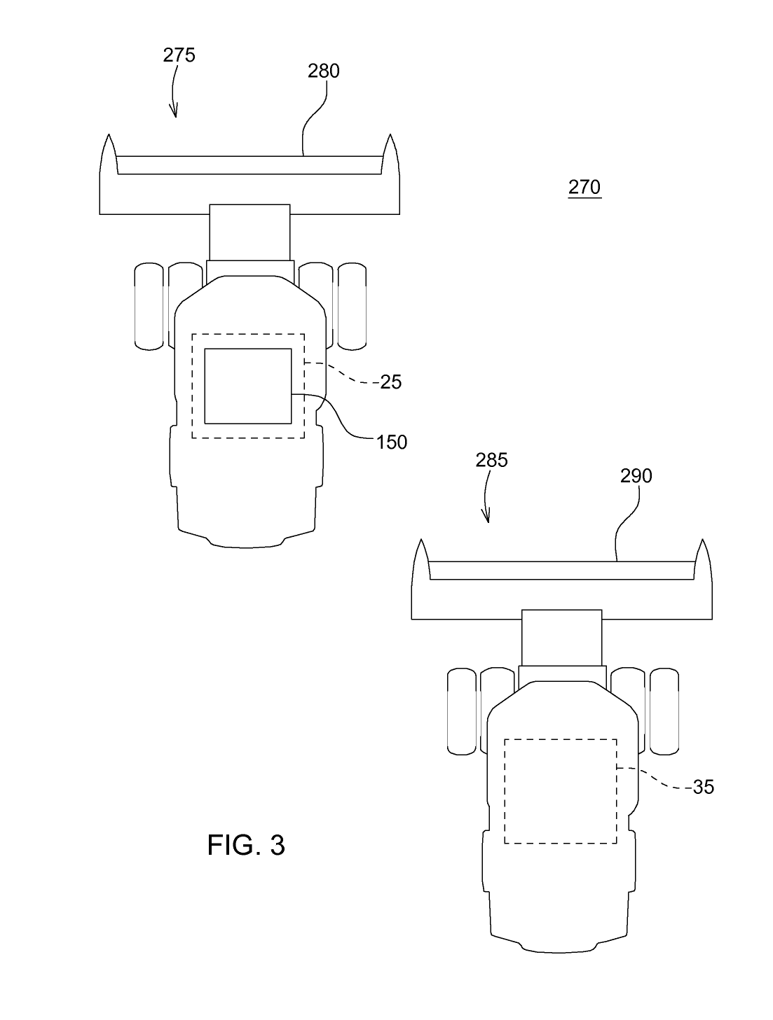

With reference to FIG. 3, the first vehicle electronics 25 may be supported on a lead vehicle 275 (e.g., combine). The lead vehicle 275 may comprise a lead implement 280 (e.g., header). The second vehicle electronics 35 may be supported on a follower vehicle 285 (e.g., combine) configured to follow the lead vehicle 275. The follower vehicle 285 may comprise a follower implement 290 (e.g., header). It is contemplated that the lead vehicle 275 may operate in front of, behind, to the left, or to the right of the follower vehicle 280. The electronic data processing system 150 may be coupled to the lead vehicle 275. The first vehicle status data 75 (FIG. 2) may pertain to the lead implement 280. The second vehicle status data 115 (FIG. 2) may pertain to the follower implement 290.

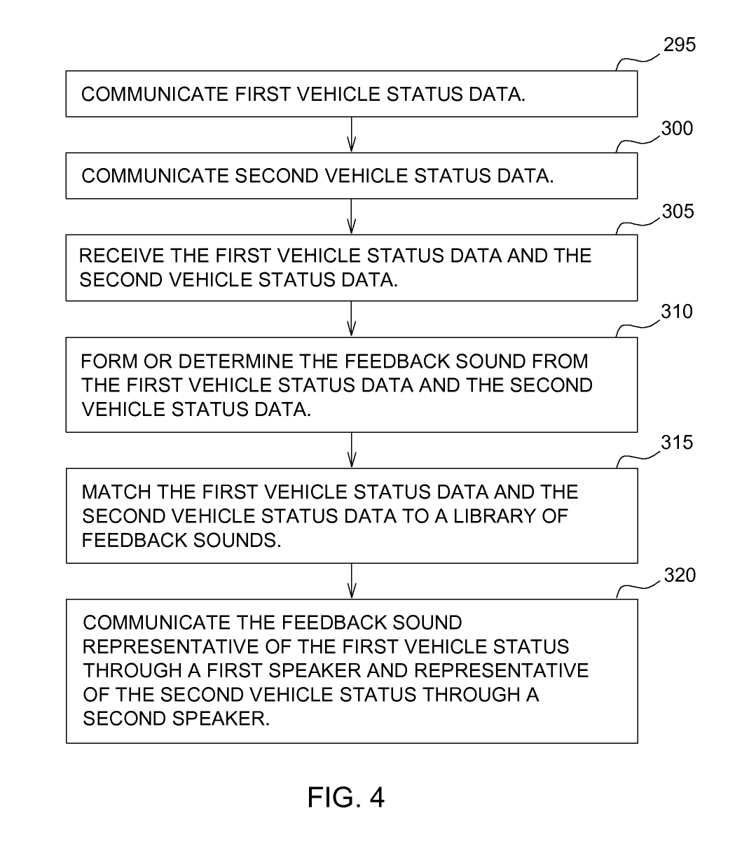

Referring to FIG. 4, a flow chart of the steps of the method for providing sound feedback to a user or manager of one or more vehicles is disclosed according to one embodiment. In step 295, the first vehicle status data 75 is communicated. In step 300, the second vehicle status data 115 is communicated. In step 305, the first vehicle status data 75 and the second vehicle status data 115 are received by an electronic data processing system 150. In step 310, the feedback sound 15 is formed or determined from the first vehicle status data 75 and the second vehicle status data 115 by a sound integration module 170. In step 315, the first vehicle status data 75 and the second vehicle status data 115 are matched to a library of feedback sounds 175 by the sound integration module 170. In step 320, the feedback sound 15 representative of the first vehicle status 20 is communicated primarily through a first speaker 260. The feedback sound 15 representative of the second vehicle status 30 is communicated primarily through a second speaker 265.

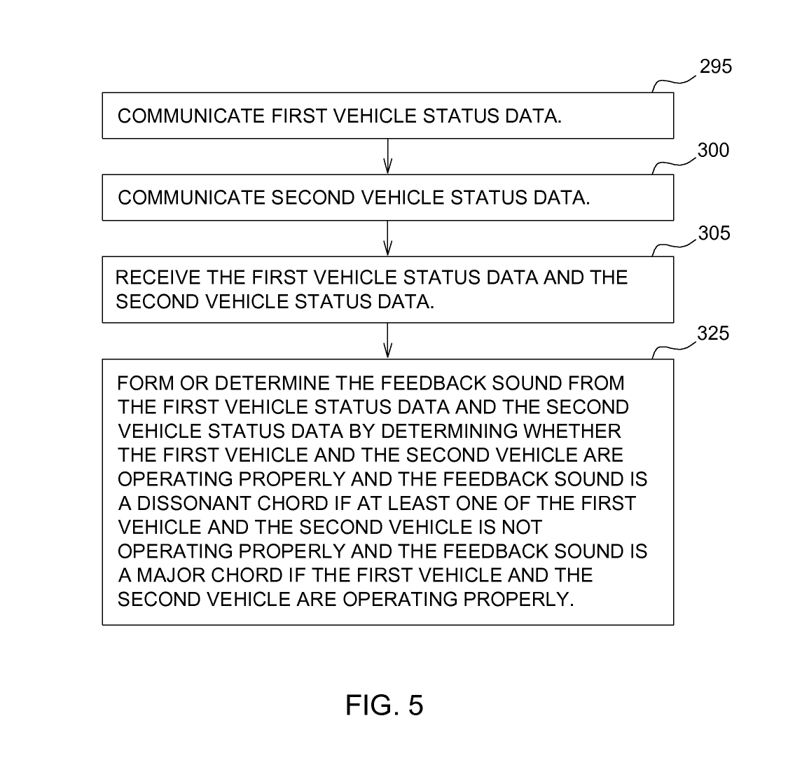

With reference to FIG. 5, a flow chart of the steps of the method for providing sound feedback to a user or manager of one or more vehicles is disclosed according to another embodiment. In step 295, the first vehicle status data 75 is communicated. In step 300, the second vehicle status data 115 is communicated. In step 305, the first vehicle status data 75 and the second vehicle status data 115 are received by an electronic data processing system 150. In step 325, the feedback sound 15 is formed or determined from the first vehicle status data 75 and the second vehicle status data 115 by determining whether the first vehicle 27 and the second vehicle 37 are operating properly. The feedback sound 15 is a dissonant chord 180 if at least one of the first vehicle 27 and the second vehicle 37 is not operating properly. The feedback sound 15 is a major chord 185 if the first vehicle 27 and the second vehicle 37 are operating properly.

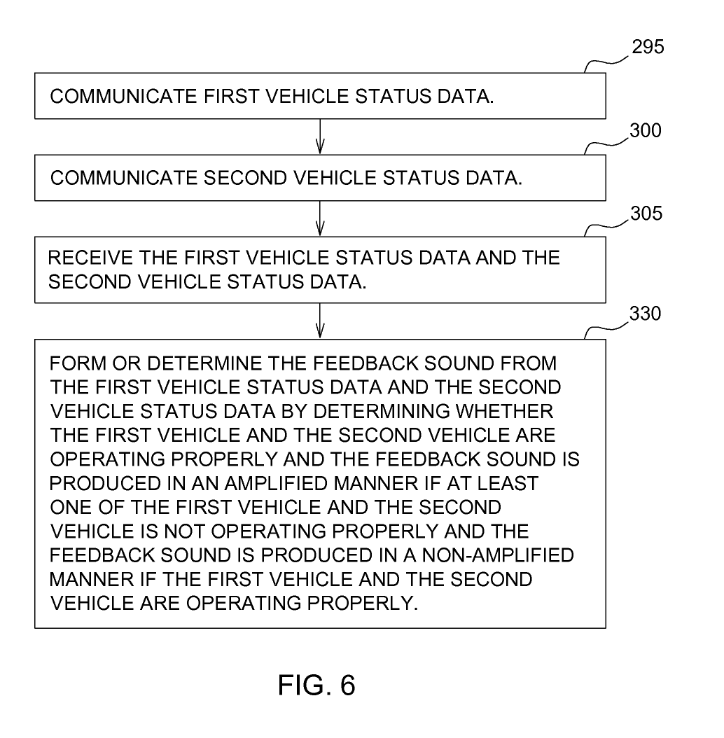

Referring to FIG. 6, a flow chart of the steps of the method for providing sound feedback to a user or manager of one or more vehicles is disclosed according to yet another embodiment. In step 295, the first vehicle status data 75 is communicated. In step 300, the second vehicle status data 115 is communicated. In step 305, the first vehicle status data 75 and the second vehicle status data 115 are received by an electronic data processing system 150. In step 330, the feedback sound 15 is formed or determined from the first vehicle status data 75 and the second vehicle status data 115 by determining whether the first vehicle 27 and the second vehicle 37 are operating properly. The feedback sound 15 is produced in an amplified manner 190 if at least one of the first vehicle 27 and the second vehicle 37 is not operating properly. The feedback sound 15 is produced in a non-amplified manner 195 if the first vehicle 27 and the second vehicle 37 are operating properly.

Advantageously, the feedback system 10 enables the user 205 to react more quickly to changing conditions by listening for the feedback sound 15. This saves fuel, prevents damage to the first vehicle 27 and the second vehicle 37, and provides other benefits.

Various features are set forth in the following claims.

What is claimed is:

1. A sound feedback system configured for providing a feedback sound representative of a first vehicle status of a first vehicle and a second vehicle status of a second vehicle, the sound feedback system comprising:
a first vehicle data bus of the first vehicle;
a second vehicle data bus of the second vehicle;
a first wireless communication device in communication with the first vehicle data bus, the first wireless communication device configured to communicate first vehicle status data;
a second wireless communication device in communication with the second vehicle data bus, the second wireless communication device configured to communicate second vehicle status data;
an electronic data processing system comprising a third wireless communication device configured to receive the first vehicle status data and the second vehicle status data;
a sound integration module configured to form or determine the feedback sound from the first vehicle status data and the second vehicle status data; and
a sound generator module configured to communicate the feedback sound to a user.

2. The sound feedback system of claim 1, further comprising at least one of a first sound sensor and a first engine RPM sensor in communication with the first vehicle data bus and at least one of a second sound sensor and a second engine RPM sensor in communication with the second vehicle data bus.

3. The sound feedback system of claim 1, wherein the first vehicle is a lead vehicle, the second vehicle is a follower vehicle configured to follow the lead vehicle, and the electronic data processing system is coupled to the lead vehicle.

4. The sound feedback system of claim 1, wherein the first wireless communication device is at least one of a first transceiver and a first transmitter, the second wireless communication device is at least one of a second transceiver and a second transmitter, and the third wireless communication device is at least one of a third transceiver and a receiver.

5. The sound feedback system of claim 1, wherein the first vehicle data bus is a first CAN bus and the second vehicle data bus is a second CAN bus.

6. The sound feedback system of claim 1, further comprising a user interface comprising a speaker, the user interface in communication with the sound generator module, the user interface configured to communicate the feedback sound through the speaker.

7. The sound feedback system of claim 1, further comprising a user interface comprising a first speaker and a second speaker, the user interface in communication with the sound generator module, the user interface configured to communicate the feedback sound representative of the first vehicle status of the first vehicle primarily through the first speaker and the feedback sound representative of the second vehicle status of the second vehicle primarily through the second speaker.

8. The sound feedback system of claim 1, wherein the sound generator module matches the first vehicle status data and the second vehicle status data to a library of feedback sounds and communicates the feedback sound.

9. The sound feedback system of claim 1, wherein the sound generator module is configured to determine whether the first vehicle and the second vehicle are operating properly and the feedback sound is a dissonant chord if at least one of the first vehicle and the second vehicle is not operating properly and the feedback sound is a major chord if the first vehicle and the second vehicle are operating properly.

10. The sound feedback system of claim 1, wherein the sound generator module is configured to determine whether the first vehicle and the second vehicle are operating properly and the feedback sound is amplified if at least one of the first vehicle and the second vehicle is not operating properly and the feedback sound is not amplified if the first vehicle and the second vehicle are operating properly.

11. A sound feedback system configured for providing a feedback sound representative of a first vehicle status of a first vehicle and a second vehicle status of a second vehicle operating together in a work area, the sound feedback system comprising:
a first vehicle data bus of the first vehicle;
a first wireless communication device in communication with the first vehicle data bus, the first wireless communication device configured to receive second vehicle status data from a second wireless communication device of a second vehicle;
in the first vehicle, an electronic data processing system configured to receive first vehicle status data and the second vehicle status data;
a sound integration module capable of forming or determining the feedback sound from the first vehicle status data and the second vehicle status data; and
a sound generator module configured to communicate the feedback sound to a user.

12. The sound feedback system of claim 11, wherein the sound generator module is configured to determine whether the first vehicle and the second vehicle are operating properly and generate a first tone representative of the first vehicle status data and a second tone representative of the second vehicle status data, if at least one of the first vehicle and the second vehicle is not operating properly the first tone and the second tone are on different frequencies or spaced apart in the frequencies of a minor chord or a dissonant sound, if the first vehicle and the second vehicle are operating properly, the first tone and the second tone are on the same frequency or spaced on frequencies that form notes of a major chord.

13. The sound feedback system of claim 11, further comprising at least one of a first sound sensor and a first engine RPM sensor in communication with the first vehicle data bus and at least one of a second sound sensor and a second engine RPM sensor in communication with a second vehicle data bus of the second vehicle.

14. The sound feedback system of claim 11, further comprising a user interface comprising a speaker, the user interface in communication with the sound generator module, the user interface configured to communicate the feedback sound through the speaker.

15. The sound feedback system of claim 11, further comprising a user interface comprising a first speaker and a second speaker, the user interface in communication with the sound generator module, the user interface configured to communicate the feedback sound representative of the first vehicle status of the first vehicle primarily through the first speaker and the feedback sound representative of the second vehicle status of the second vehicle primarily through the second speaker.

16. A method for providing a feedback sound representative of a first vehicle status of a first vehicle and a second vehicle status of a second vehicle, the method comprising:
communicating first vehicle status data;
communicating second vehicle status data;
receiving the first vehicle status data and the second vehicle status data;
forming or determining the feedback sound from the first vehicle status data and the second vehicle status data; and
communicating the feedback sound to a user.

17. The method of claim 16, further comprising communicating the feedback sound representative of the first vehicle status of the first vehicle primarily through a first speaker and communicating the feedback sound representative of the second vehicle status of the second vehicle primarily through a second speaker.

18. The method of claim 16, further comprising matching the first vehicle status data and the second vehicle status data to a library of feedback sounds and communicating the feedback sound.

19. The method of claim 16, further comprising determining whether the first vehicle and the second vehicle are operating properly and the feedback sound is a dissonant chord if at least one of the first vehicle and the second vehicle is not operating properly and the feedback sound is a major chord if the first vehicle and the second vehicle are operating properly.

20. The method of claim 16, further comprising determining whether the first vehicle and the second vehicle are operating properly and the feedback sound is amplified if at least one of the first vehicle and the second vehicle is not operating properly and the feedback sound is not amplified if the first vehicle and the second vehicle are operating properly.
